(19) United States
(12) Patent Application Publication
(10) Pub. No.: US 2020/0002515 A1
(43) Pub. Date: Jan. 2, 2020

(54) HNBR ELASTOMERIC COMPOSITIONS

(71) Applicant: Zeon Chemical L.P., Louisville, KY (US)

(72) Inventor: Dana Stripe, Henryville, IN (US)

(21) Appl. No.: 16/456,875

(22) Filed: Jun. 28, 2019

Related U.S. Application Data
(60) Provisional application No. 62/691,861, filed on Jun. 29, 2018.

(51) Int. Cl. C08L 9/02; C08K 5/00; C08K 3/013; C08K 3/22; C08K 3/34; C08K 5/14; C08L 15/00

(52) U.S. Cl. CPC C08L 9/02; C08K 5/005; C08K 3/013; C08K 3/22; C08L 2312/00; C08K 5/14; C08L 15/005; C08K 2003/222; C08K 3/34

(57) ABSTRACT

An elastomeric composition comprising hydrogentated nitrile butadiene rubber (HNBR), maleinized polybutadiene, and metal oxide. In addition, they optionally comprise a cure system, fillers, and other additives. In some embodiments, the metal oxide comprises one or more compounds selected from magnesium oxide, zinc oxide, and hydrotalcite. The elastomeric composition has improved swell resistance when exposed to water.

### CROSS REFERENCE TO RELATED APPLICATIONS

The present application hereby claims the benefit of the provisional patent application titled “Improved HNBR,” Ser. No. 62/691,861, filed on Jun. 29, 2019, the disclosure of which is herein incorporated by reference in its entirety.

### BACKGROUND

Elastomers containing hydrogentated nitrile butadiene rubber (HNBR) compounds may be used in various applications, such as materials that come into contact with hydrocarbon fluids. However, when some elastomers come into contact with water, they can swell which changes their dimensions and properties.

### BRIEF SUMMARY

An elastomeric composition comprising hydrogentated nitrile butadiene rubber (HNBR), maleinized polybutadiene, and metal oxide.

These and other objects and advantages shall be made apparent from the accompanying drawings and the description thereof.

### DETAILED DESCRIPTION

Elastomeric compositions comprise hydrogentated nitrile butadiene rubber (HNBR), maleinized polybutadiene, and metal oxide. In addition, they optionally comprise a cure system, fillers, and other additives.

Maleinized polybutadiene is a polymer of polybutadiene that has been grafted to maleic anhydride, which becomes succinic anhydride. In some embodiments, the molecular weight of the maleinized polybutadiene ranges from about 1,400 g/mol to about 8,600 g/mol, such as from about 1,400 to about 8,000; about 1,400 to about 6,000; about 1,400 to about 5,300; about 1,400 to about 3,200; about 1,400 to about 2,000; about 2,000 to about 8,000; about 2,000 to about 6,000; about 2,000 to about 5,300; about 3,200 to about 8,000; about 3,200 to about 6,000, about 3,200 to about 5,300 g/mol, about 1,400 to about 3,200, and about 2,000 to about 3,200. In some embodiments, the 1,2 vinyl content is from about 28% to about 90%, such as about 30% to about 90%; about 40% to about 90%; about 65% to about 90%; about 28% to about 65%; and about 28% to about 40%.

In some embodiments, the metal oxide is selected from CaO, CuO, TiO₂, Fe₂O₃, Al₂O₃, Sb₂O₃, MgO, ZnO, hydrotalcite, and mixtures thereof. In some embodiments, the metal oxide is selected from magnesium oxide, zinc oxide, hydrotalcite, and mixtures thereof. In some embodiments, the metal oxide is magnesium oxide. In some embodiments, the metal oxide is hydrotalcite. Hydrotalcite is magnesium aluminum hydroxy carbonate. In some embodiments, the metal oxide has a surface area of 160-180 m²/g. In some embodiments, the metal oxide has a surface area of 8-9 m²/g. In some embodiments, the metal oxide has a mean particle size of about 0.10 microns to about 0.25 microns.

The elastomeric composition comprises HNBR, maleinized polybutadiene, and metal oxide. The amounts, by mass, of the other ingredients are typically compared to the amount of elastomeric polymer (HNBR and any additional elastomeric polymers), by mass, using the unit phr (per hundred of rubber). The amount of maleinized polybutadiene ranges from greater than 0 phr to about 20 phr, such as about 1 phr to about 20 phr, about 1 phr to about 15 phr, about 5 phr to about 20 phr, about 7 phr to about 20 phr, about 10 phr to about 20 phr, about 15 phr to about 20 phr, and about 1 phr to about 10 phr. The amount of metal oxide ranges from greater than 0 to about 50 phr, such as about 1 phr to about 50 phr, about 1 phr to about 40 phr, about 1 phr to about 30 phr, about 1 phr to about 20 phr, about 10 phr to about 50 phr, about 20 phr to about 50 phr, about 30 phr to about 50 phr, and about 10 phr to about 40 phr. In some embodiments, the amount of hydrotalcite ranges from greater than 0 phr to about 26 phr, about 1 phr to about 25 phr, about 1 phr to about 20 phr, about 1 phr to about 10 phr, about 1 phr to about 5 phr, about 5 phr to about 26 phr, about 10 phr to about 25 phr, about 15 phr to about 25 phr, and about 5 phr to about 20 phr.

In some embodiments, the elastomeric compound further comprises one or more elastomeric polymers. Examples of elastomers include, but are not limited to ethylene propylene diene rubber (EPDM), nitrile rubber (NBR), ethylene vinyl acetate (EVM), chlorosulfonated polyethylene (CSM), chlorinated polyethylene (CM), styrene butadiene rubber (SBR), chloroprene rubber (CR), and combinations thereof.

In some embodiments, the cure system is peroxide cure system that is used with heat to vulcanize the elastomeric compound to produce the elastomeric rubber. In some embodiments, the peroxide cure, uses 0.5-20 phr dialkyl peroxide curative such as dicumyl peroxide, or 1,3 1,4-bis(tert-butylperoxyisopropyl)benzene. However, other peroxides classes are also known to be effective such as peroxyketals which include 1,1′-di(t-butylperoxy)-3,3,5-trimethylcyclohexane and n-butyl-4,4′-di(t-butylperoxy)valerate.

In some embodiments, these peroxides are used with 0-30 phr of a co-agent that increases the efficiency of the peroxide and increases the crosslink network. These co-agents include a wide range of materials with various amounts of unsaturation that are highly reactive with the peroxide. Examples of these include materials such as acrylates and methacrylates such as tri-methylol-propane tri-acraylate (TMPTA), trimethylol-propane-trimethacrylate (TMPTMA/SR-517), 1,3-butylene glycol dimethacrylate, or ethylene glycol dimethacrylate. Other co-agents widely used include triallyl cyanurate (TAIC), triallyl cyanurate (TAC), and N,N′-1,3-phenylene bismaleimide. Additionally, modified polybutadiene can be used. These materials are sold by Cray Valley under the trade names of Ricon or Ricobond. The Ricobond 1756HS contains a high vinyl maleinized polybutadiene which has been blended with a silica carrier for easier handling.

In some embodiments, the elastomeric compound comprises one or more additive, such as a plasticizer. Examples of plasticizers include, but are not limited to monomeric and polymeric adipates, sebacates, and trimellitates, such as trioctyl trimellitate (“Plasthall TOTM” supplied by Hallstar), dibutoxyethoxyethyl adipate (“TP-95” supplied by Hallstar), polyester sebacate (“Paraplex G50” supplied by Hallstar), polyester sebacate (“Paraplex G-25” supplied by Hallstar), polyester adipate (“Paraplex A-8600” supplied by Hallstar), or any other monomeric or polymeric plasticizer that would reduce hardness, reduce compound Mooney viscocity, or reduce overall cost of the compound by allowing for increased filler levels. In some embodiments, the plasticizer loadings is from about 0 phr to about 50 phr, such as from about 0 to about 20 phr, and from about 0 to about 10 phr.

Examples of mineral filler include, but are not limited to silica, silicate, calcium carbonate, clay, titanium oxide, antimony oxide, and a combination thereof. In some embodiments, the mineral filler comprises silica or silicate. In some embodiments, the filler comprises carbon black. In some embodiments, the elastomeric rubber comprises about 0 to about 100 phr mineral filler, such as about 30 to about 70 phr, about 20 to about 60 phr, and about 30 to about 50 phr. The filler may be modified to adjust the hardness, tensile strength, and tear strength of the compound. Mineral fillers are known for imparting improved flex, tear, and extension over carbon black recipes. These attributes are due to hydrogen bonding that is formed between the aggregates and the polymer.

Examples of carbon black include, but are not limited to aggregates of coalesced spherical particles formed by incomplete combustion or thermal decomposition of hydrocarbons. There are two main processes in active production; they are referred to as thermal and furnace production methods. There are many grades of carbon black on the market. These materials are differentiated by surface area and structure. Carbon black recipes are better suited for water and coolant applications than mineral filled compounds. Mineral filled recipes tend to have higher volume and property change due to the hydroscopic nature of mineral fillers. Carbon black recipes also form stronger more stable van-der-walls interactions between the aggregates and the polymer than mineral fillers can on their own.

In some embodiments, the elastomeric composition comprises one or more additive, such as antioxidants, which improve long-term property retention. Antioxidants help to extend the elastomeric life of the compound by preventing oxidation and thermal decomposition of the polymer. In some embodiments, the antioxidants used with peroxide curatives are blends of imidazoles and hindered amines or quinolines. The imidazole family includes 2,2,4-trimethyl-1,2-dihydroquinoline (TMQ), 2-mercaptotoluimidazole or 4- and 5-Methyl-2-mercaptobenzimidazole (MTI), 2-mercaptobenzimidazole (MBI), zinc 2-mercaptotoluimidazole or 4- and 5-methyl-2-mercaptobenzimidazole (ZMTI), zinc 2-mercaptotoluimidazole or 4- and 5-methyl-2-mercaptobenzimidazole (ZMBI). In some embodiments, the imidazole is combined with a hindered amine, such as 4,4′-bis(dimethylbenzyl)diphenylamine (CDPA) or 2-dihydro-2,2,4-trimethylquinoline (TMQ).

While the present disclosure has illustrated by description several embodiments and while the illustrative embodiments have been described in considerable detail, it is not the intention of the applicant to restrict or in any way limit the scope of the appended claims to such detail. Additional advantages and modifications may readily appear to those skilled in the art.

### EXAMPLES

### Examples 1-16

All compounds were mixed in a 1.5 L intermeshing mixer with a two-stage mixing sequence to ensure good dispersion of all materials. The first stage is mixed to 140° C.-150° C. and then discharged from the mixer and allowed to cool to room temperature. The curatives are than added on a two-roll mill and blended until all material has been incorporated.

ASTM testing methods were used.

Testing methods

| Test | ASTM |
|---|---|
| Measurements of Rubber | D412 |
| Properties in Tension | |
| Determination of swell in | D471 |
| Liquids | |
| Deterioration in an Air | D573 |
| Oven | |
| Durometer Hardnes | D2240 |

Ingredients for Examples 1-16

| | Maglite | | | | |
|---|---|---|---|---|---|
| Example | D | Hydrotalcite | RICOBOND | Paraplex | Plasthall |
| 1 | 2.50 | 2.50 | 1.00 | 5.00 | 5.00 |
| 2 | | 5.00 | 2.00 | | 10.00 |
| 3 | | 5.00 | 2.00 | 10.00 | |
| 4 | | 5.00 | | 10.00 | |
| 5 | 5.00 | | | 10.00 | |
| 6 | 5.00 | | | | 10.00 |
| 7 | | 5.00 | | | 10.00 |
| 8 | 5.00 | | 2.00 | 10.00 | |
| 9 | 5.00 | | 2.00 | | 10.00 |
| 10 | 2.50 | 2.50 | 1.00 | 2.50 | 7.50 |
| 11 | 2.50 | 2.50 | 1.00 | 7.50 | 2.50 |
| 12 | 2.50 | 2.50 | 0.50 | 5.00 | 5.00 |
| 13 | 1.25 | 3.75 | 1.00 | 5.00 | 5.00 |
| 14 | 2.50 | 2.50 | 1.00 | 5.00 | 5.00 |
| 15 | 3.75 | 1.25 | 1.00 | 5.00 | 5.00 |
| 16 | 2.50 | 2.50 | 1.50 | 5.00 | 5.00 |

RICOBOND is RICOBOND 1756 HS, Paraplex is Paraplex A-8600, and Plasthall is Plasthall TOTM.

The remaining common ingredients for examples 1-16 are:

Common Ingredients for Examples 1-16

| Ingredient | Amount |
|---|---|
| Zetpol 1010 | 40.00 |
| ZETPOL 1010EP | 60.00 |
| N762 | 15.00 |
| N326 | 15.00 |
| N990 | 15.00 |
| Vanox CDPA | 1.50 |
| Vanox MTI | 1.00 |
| SR517 | 8.00 |
| Luperox F40P-SP2 | 10.00 |

Zetpol 1010 - hydrogenated acrylo nitrile rubber 44 ACN/85MV/96 HYD-Polymer
Zetpol 1010EP - hydrogenated acrylo nitrile rubber 44 ACN/30MV/96 HYD-Polymer
N762/N326/N990 - carbon black - reinforcement
Vanox CDPA - 4,4′-bis (α,α-dimethylbenzyl) diphenylamine - antioxidant
Vanox MTI - zinc 2-mercaptotoluimidazole - antioxidant
SR517 - Trimethylolpropane Trimethacrylate (scorch retarded) - co-agent
Luperox F40P-SP2 - 1,3 1,4-Bis(tert-butylperoxyisopropyl)benzene (Scorch Retarded) - Peroxide cure

Aged Vulcanized, Parr Pressure Vessel, Distilled Water,
168H/150° C. Results

| | Hardness | | | |
|---|---|---|---|---|
| | Change A, | Tensile | Elongation | Volume |
| Example | (pts) | Change, (%) | Change, (%) | Change, (%) |
| 1 | −13 | −21 | −38 | 78.8 |
| 2 | −1 | −4 | −5 | 6.2 |
| 3 | 1 | −1 | −10 | 7.1 |
| 4 | 0 | −3 | −16 | 8.6 |
| 5 | −19 | −38 | −59 | 137.4 |
| 6 | −13 | −31 | −48 | 63.3 |
| 7 | 1 | −8 | −11 | 4.0 |
| 8 | −7 | −21 | −39 | 58.0 |
| 9 | −6 | −19 | −26 | 30.0 |
| 10 | 2 | −5 | −27 | 27.1 |
| 11 | −4 | −7 | −24 | 52.4 |
| 12 | 0 | −4 | −24 | 31.0 |
| 13 | 3 | −2 | −6 | 6.1 |
| 14 | −5 | −15 | −35 | 49.6 |
| 15 | −5 | −16 | −32 | 55.6 |
| 16 | −4 | −14 | −31 | 37.6 |

Aged Vulcanized, IRM 903, 500H/135° C. Results

| | Hardness | | | |
|---|---|---|---|---|
| | Change A, | Tensile | Elongation | Volume |
| Example | (pts) | Change, (%) | Change, (%) | Change, (%) |
| 1 | 5 | −10 | −33 | 2.4 |
| 2 | 5 | −29 | −45 | 0.9 |
| 3 | 4 | −25 | −54 | 3.9 |
| 4 | 5 | −13 | −43 | 4.7 |
| 5 | 5 | −16 | −45 | 4.6 |
| 6 | 8 | −16 | −49 | −0.1 |
| 7 | 8 | −22 | −49 | −0.6 |
| 8 | 3 | −28 | −52 | 5.0 |
| 9 | 8 | −34 | −56 | −0.8 |
| 10 | 6 | −13 | −45 | 1.0 |
| 11 | 4 | −18 | −42 | 3.4 |
| 12 | 4 | −11 | −43 | 2.0 |
| 13 | 5 | −24 | −49 | 2.1 |
| 14 | 4 | −8 | −44 | 2.3 |
| 15 | 4 | −22 | −49 | 2.3 |
| 16 | 3 | −21 | −50 | 2.1 |

IRM—International Reference Oil 903

Aged Vulcanized, Air, 504H/150° C. Results

| | Hardness | | |
|---|---|---|---|
| | Change A, | Tensile | Elongation |
| Example | (pts) | Change, (%) | Change, (%) |
| 1 | 17 | 3 | −37 |
| 2 | 13 | −15 | −61 |
| 3 | 11 | 8 | −62 |
| 4 | 11 | −10 | −61 |
| 5 | 15 | 4 | −44 |
| 6 | 18 | 8 | −58 |
| 7 | 18 | 0 | −61 |
| 8 | 11 | 6 | −47 |
| 9 | 18 | −14 | −70 |
| 10 | 16 | 0 | −55 |
| 11 | 12 | 0 | −51 |
| 12 | 13 | 8 | −53 |
| 13 | 13 | 15 | −54 |
| 14 | 13 | 11 | −57 |
| 15 | 15 | 2 | −55 |
| 16 | 13 | 9 | −60 |

Aged Vulcanized, Air, 1008H/150° C. Results

| | Hardness | | |
|---|---|---|---|
| | Change A, | Tensile | Elongation |
| Example | (pts) | Change, (%) | Change, (%) |
| 1 | 20 | 2 | −56 |
| 2 | 19 | −3 | −73 |
| 3 | 15 | −12 | −77 |
| 4 | 16 | 2 | −71 |
| 5 | 18 | −2 | −60 |
| 6 | 22 | 1 | −73 |
| 7 | 22 | −16 | −77 |
| 8 | 15 | 2 | −62 |
| 9 | 23 | −13 | −82 |
| 10 | 19 | 4 | −72 |
| 11 | 14 | 1 | −66 |
| 12 | 17 | 8 | −66 |
| 13 | 17 | 6 | −71 |
| 14 | 17 | −11 | −74 |
| 15 | 18 | −6 | −71 |
| 16 | 17 | −2 | −74 |

### Examples 17-20, Controls with ZnO and MgO

These compositions were made in the same manner as described for Example 1.

Ingredients for Examples 21-25

| Example | Zinc Oxide | MgO |
|---|---|---|
| 17 | | |
| 18 | 5.00 | |
| 19 | | 5.00 |
| 20 | 5.00 | 5.00 |

Ingredients for Examples 17-20

| Ingredient | Amount |
|---|---|
| Zetpol 2010 | 100.00 |
| N774 | 50.00 |
| Naugard 445 | 1.50 |
| Vanox MTI | 1.00 |
| Plasthall TOTM | 5.00 |
| Vul-Cup 40KE | 8.00 |

Aged Vulcanized, Air, 504H/150° C. Results

| | Hardness | | |
|---|---|---|---|
| | Change A, | Tensile | Elongation |
| Example | (pts) | Change, (%) | Change, (%) |
| 17 | 16 | 9 | −70 |
| 18 | 13 | −6 | −45 |
| 19 | 12 | −6 | −42 |
| 20 | 15 | −8 | −36 |

### Examples 21-25, Hydrotalcite and Zinc Oxide

These compositions were made in the same manner as described for Example 1.

Ingredients for Examples 21-25

| | | Zinc Oxide | Plasthall | Paraplex G62 |
|---|---|---|---|---|
| Example | Hydrotalcite | XFT-H | TOTM | (ESBO) |
| 21 | 5.00 | | | 5.00 |
| 22 | 2.50 | 2.50 | 2.50 | 2.50 |
| 23 | | 5.00 | | 5.00 |
| 24 | | 5.00 | 5.00 | |
| 25 | 5.00 | | 5.00 | |

Common Ingredients for Examples 21-25

| Ingredient | Amount |
|---|---|
| Zetpol 2000L | 75.00 |
| ZETPOL 2000EP | 25.00 |
| N990 | 75.00 |
| Vanox CDPA | 1.50 |
| Vanox ZMTI | 1.00 |
| Vanox MBM | 1.00 |
| SR517 | 2.00 |
| TRIGONOX 17-40 | 11.00 |
| LUPEROX DC40P-SP2 | 5.25 |

Aged Vulcanized, Air, 70H/150° C. Results

| | Hardness | | |
|---|---|---|---|
| | Change A, | Tensile | Elongation |
| Example | (pts) | Change, (%) | Change, (%) |
| 21 | 6 | −6 | −30 |
| 22 | 7 | −4 | −19 |
| 23 | 8 | −2 | −18 |
| 24 | 7 | −5 | −19 |
| 25 | 8 | 1 | 1 |

Aged Vulcanized, IRM 903, 70H/150° C. Results

| | Hardness | | | |
|---|---|---|---|---|
| | Change A, | Tensile | Elongation | Volume |
| Example | (pts) | Change, (%) | Change, (%) | Change, (%) |
| 21 | −5 | 3 | −12 | 10.5 |
| 22 | −5 | 7 | 2 | 10.6 |
| 23 | −3 | −4 | −18 | 10.6 |
| 24 | −3 | 0 | −4 | 10.0 |
| 25 | −2 | 10 | 2 | 10.1 |

Aged Vulcanized, Air, 504H/150° C. Results

| | Hardness | | |
|---|---|---|---|
| | Change A, | Tensile | Elongation |
| Example | (pts) | Change, (%) | Change, (%) |
| 21 | 10 | −8 | −38 |
| 22 | 11 | −8 | −25 |
| 23 | 14 | −9 | −41 |
| 24 | 12 | −11 | −28 |
| 25 | 12 | −6 | −16 |

Aged Vulcanized, IRM 903, 504H/135° C. Results

| | Hardness | | | |
|---|---|---|---|---|
| | Change A, | Tensile | Elongation | Volume |
| Example | (pts) | Change, (%) | Change, (%) | Change, (%) |
| 21 | −3 | −2 | −24 | 12.3 |
| 22 | −3 | −4 | −13 | 12.4 |
| 23 | −2 | −5 | −19 | 12.2 |
| 24 | −2 | 4 | −19 | 11.2 |
| 25 | −2 | 11 | −3 | 11.2 |

Aged Vulcanized, Air, 1008H/150° C. Results

| | Hardness | | |
|---|---|---|---|
| | Change A, | Tensile | Elongation |
| Example | (pts) | Change, (%) | Change, (%) |
| 21 | 13 | −7 | −43 |
| 22 | 15 | −4 | −38 |
| 23 | 17 | −1 | −49 |
| 24 | 16 | −5 | −41 |
| 25 | 14 | −7 | −32 |

Aged Vulcanized, IRM, 1008H/135° C. Results

| | Hardness | | |
|---|---|---|---|
| | Change A, | Tensile | Elongation |
| Example | (pts) | Change, (%) | Change, (%) |
| 21 | −5 | −2 | −23 |
| 22 | −2 | −12 | −30 |
| 23 | 2 | −15 | −36 |
| 24 | 5 | −27 | −48 |
| 25 | −4 | 3 | −18 |

### Examples 26-27, Hydrotalcite/MgO Compared to ZnO

These compositions were made in the same manner as described for Example 1.

Ingredients for Examples 26-27

| Example | Zinc Oxide | Hydrotalcite | Maglite | Vanox ZMTI |
|---|---|---|---|---|
| 26 | 3.00 | | | 1.00 |
| 27 | | 3.00 | 3.00 | 1.50 |

Ingredients for Examples 26-27

| Ingredient | Amount |
|---|---|
| Zetpol 2010L | 100.00 |
| N774 | 40.00 |
| Vanox CDPA | 1.50 |
| Plasthall TOTM | 5.00 |
| Vul-Cup 40KE | 9.00 |

Aged Vulcanized, Air, 504H/150° C. Results

| | Hardness | | |
|---|---|---|---|
| | Change A, | Tensile | Elongation |
| Example | (pts) | Change, (%) | Change, (%) |
| 26 | 13 | −13 | −33 |
| 27 | 15 | −18 | −18 |

Aged Vulcanized, Air, 1008H/150° C. Results

| | Hardness | | |
|---|---|---|---|
| | Change A, | Tensile | Elongation |
| Example | (pts) | Change, (%) | Change, (%) |
| 26 | 18 | −14 | −57 |
| 27 | 17 | −19 | −30 |

Aged Vulcanized, IRM, 1008H/150° C. Results

| | Hardness | | |
|---|---|---|---|
| | Change A, | Tensile | Elongation |
| Example | (pts) | Change, (%) | Change, (%) |
| 26 | 16 | −68 | −66 |
| 27 | −2 | −63 | −50 |

Aged Vulcanized, IRM, 1008H/135° C. Results

| | Hardness | | |
|---|---|---|---|
| | Change A, | Tensile | Elongation |
| Example | (pts) | Change, (%) | Change, (%) |
| 26 | −2 | −55 | −47 |
| 27 | −2 | −46 | −40 |

### Examples 28-37, Higher Loadings of Ricobond with Co-Agent and Peroxide

These compositions were made in the same manner as described for Example 1.

Ingredients for Examples 28-37

| | | | Ricobond | Luperox |
|---|---|---|---|---|
| Example | SR517 | HVA2 | 1756 HS | F40P-SP2 |
| 28 | 8.00 | | | 8.00 |
| 29 | | 8.00 | 6.00 | 12.00 |
| 30 | 4.00 | 4.00 | 3.00 | 10.00 |
| 31 | 8.00 | | 6.00 | 12.00 |
| 32 | | 8.00 | | 12.00 |
| 33 | 8.00 | | 6.00 | 8.00 |
| 34 | 8.00 | | | 12.00 |
| 35 | | 8.00 | 6.00 | 8.00 |
| 36 | | 8.00 | | 8.00 |
| 37 | 2.7 | 5.3 | 4.5 | 8.73 |

The remaining common ingredients for examples 28-37 are:

Common Ingredients for Examples 28-37

| Ingredient | Amount |
|---|---|
| Zetpol 1010 | 40.00 |
| ZETPOL 1010EP | 60.00 |
| N762 | 15.00 |
| N326 | 15.00 |
| N990 | 15.00 |
| Hydrotalcite | 5.00 |
| Vanox CDPA | 1.50 |
| Vanox MTI | 1.00 |
| Paraplex A-8600 | 5.00 |
| Plasthall TOTM | 5.00 |

Aged Vulcanized, Water, 168H/150° C. Results

| | Tensile | Elongation | Volume |
|---|---|---|---|
| Example | Change, (%) | Change, (%) | Change, (%) |
| 28 | −6 | −20 | 15.7 |
| 29 | 2 | 28 | −0.1 |
| 30 | −3 | 14 | 4.9 |
| 31 | 6 | 11 | −0.5 |
| 32 | −12 | 43 | 15.0 |
| 33 | −1 | −5 | 5.7 |
| 34 | 0 | −7 | 10.3 |
| 35 | −13 | 18 | 1.6 |
| 36 | −20 | 11 | 19.8 |
| 37 | −1 | 10 | 1.5 |

### Examples 38-54, Higher Loadings of Ricobond and TAIC/SR517 Blends

These compositions were made in the same manner as described for Example 1.

Ingredients for Examples 38-54

| | | | | Ricobond | Luperox |
|---|---|---|---|---|---|
| Example | N990 | TAIC | SR517 | 1756 HS | F40P-SP2 |
| 38 | 25.00 | 8.00 | | 6.00 | 12.00 |
| 39 | 15.00 | 8.00 | | 6.00 | 8.00 |
| 40 | 25.00 | | 8.00 | 6.00 | 8.00 |
| 41 | 15.00 | 8.00 | | | 12.00 |
| 42 | 25.00 | 8.00 | | | 8.00 |
| 43 | 15.00 | | 8.00 | | 8.00 |
| 44 | 20.00 | 4.00 | 4.00 | 3.00 | 10.00 |
| 45 | 15.00 | | 8.00 | 6.00 | 12.00 |
| 46 | 25.00 | | 8.00 | | 12.00 |
| 47 | 15.00 | | 8.00 | 6.00 | 8.00 |
| 48 | 25.00 | | 8.00 | | 8.00 |
| 49 | 25.00 | 8.00 | | | 12.00 |
| 50 | 15.00 | 8.00 | | 6.00 | 12.00 |
| 51 | 15.00 | | 8.00 | | 12.00 |
| 52 | 25.00 | 8.00 | | 6.00 | 8.00 |
| 53 | 15.00 | 8.00 | | | 8.00 |
| 54 | 25.00 | | 8.00 | 6.00 | 12.00 |

The remaining common ingredients for examples 38-54 are:

Common Ingredients for Examples 38-54

| Ingredient | Amount |
|---|---|
| Zetpol 1010 | 40.00 |
| ZETPOL 1010EP | 60.00 |
| N326 | 30.00 |
| Hydrotalcite | 5.00 |
| Vanox CDPA | 1.50 |
| Vanox MTI | 1.00 |
| Paraplex A-8600 | 5.00 |
| Plasthall TOTM | 5.00 |

Aged Vulcanized, Parr Pressure Vessel, Distilled
Water, 504H/150° C. Results

| | Hardness | | | |
|---|---|---|---|---|
| | Change A, | Tensile | Elongation | Volume |
| Example | (pts) | Change, (%) | Change, (%) | Change, (%) |
| 38 | 8 | 14 | −10 | −3.8 |
| 39 | 8 | 6 | −20 | −2.2 |
| 40 | 7 | 8 | −21 | −1.9 |
| 41 | 8 | 6 | −11 | −2.5 |
| 42 | 2 | 0 | −22 | 10.3 |
| 43 | −1 | −10 | −26 | 22.3 |
| 44 | 3 | 7 | −3 | 0.6 |
| 45 | 3 | −5 | −11 | −2.0 |
| 46 | 5 | −3 | −5 | 1.6 |
| 47 | 4 | 3 | −11 | −0.1 |
| 48 | −1 | 0 | −28 | 15.7 |
| 49 | 5 | −9 | −17 | −0.3 |
| 50 | 7 | 9 | −5 | −3.7 |
| 51 | 1 | −8 | −9 | 6.5 |
| 52 | 6 | 5 | −18 | −2.0 |
| 53 | 4 | −7 | −23 | 2.7 |
| 54 | 5 | 3 | −5 | −3.2 |

What is claimed is:

1. An elastomeric composition comprising hydrogentated nitrile butadiene rubber (HNBR), maleinized polybutadiene, and metal oxide.

2. The elastomeric composition of claim 1, wherein the metal oxide comprises one or more compounds selected from magnesium oxide, zinc oxide, and hydrotalcite.

3. The elastomeric composition of claim 2, wherein the metal oxide comprises hydrotalcite.

4. The elastomeric composition of claim 2, wherein the metal oxide comprises magnesium oxide.

5. The elastomeric composition of claim 2, wherein the metal oxide comprises magnesium oxide and hydrotalcite.

6. The elastomeric composition of claim 1, wherein the amount of maleinized polybutadiene ranges from greater than 0 phr to about 20 phr.

7. The elastomeric composition of claim 1, wherein the amount of metal oxide ranges from greater than 0 phr to about 50 phr.

8. The elastomeric composition of claim 6, wherein the amount of metal oxide ranges from greater than 0 phr to about 50 phr.

9. The elastomeric composition of claim 8, wherein the metal oxide comprises hydrotalcite.

10. The elastomeric composition of claim 9, wherein the amount of metal oxide ranges from greater than 0 phr to about 26 phr.

11. The elastomeric composition of claim 1, further comprising a peroxide cure system.

12. The elastomeric composition of claim 1, further comprising one or more filler.

13. The elastomeric composition of claim 12, wherein the filler comprises a mineral filler.

14. The elastomeric composition of claim 1, further comprising an antioxidant.
